(19) United States
(12) Patent Application Publication
(10) Pub. No.: US 2012/0170744 A1
(43) Pub. Date: Jul. 5, 2012

(54) Mobile Communication Devices and Deciphering Methods

(75) Inventor: Tsung-Yo CHENG, Taipei Hsien (TW)

(73) Assignee: ACER INCORPORATED, Taipei Hsien (TW)

(21) Appl. No.: 13/105,119

(22) Filed: May 11, 2011

(30) Foreign Application Priority Data
Dec. 31, 2010 (TW) 99147224

(51) Int. Cl. H04W 12/00

(52) U.S. Cl. 380/270

(57) ABSTRACT

A wireless communications device with a wireless module and a controller module is provided. The wireless module is arranged for performing wireless transmission and reception to and from a service network. The controller module is arranged for receiving a first ciphered data packet from the service network via the wireless module, and deciphering the first ciphered data packet according to a first deciphering parameter. Also, the controller module is arranged for deciphering the first ciphered data packet according to a second deciphering parameter in response to unsuccessful deciphering of the first ciphered data packet according to the first deciphering parameter. Particularly, the second deciphering parameter is for deciphering a second ciphered data packet received prior to the first ciphered data packet from the service network.

### CROSS REFERENCE TO RELATED APPLICATIONS

This Application claims priority of Taiwan Patent Application No. 99147224, filed on Dec. 31, 2010, the entirety of which is incorporated by reference herein.

### BACKGROUND OF THE INVENTION

1. Field of the Invention

The invention generally relates to the field of mobile communications, and more particularly, to ciphering and deciphering of data wirelessly transceiving in mobile communication systems.

2. Description of the Related Art

In a typical mobile communication system, a User Equipment (UE) and a service network may apply ciphering/deciphering for data transmission and reception therebetween, to assure the confidentiality of information. At the transmitting end, data is ciphered before being transmitted, and at the receiving end, the ciphered data is deciphered so that data content may be recognized. FIG. 1 is a block diagram illustrating the ciphering and deciphering of data communicated in a Universal Mobile Telecommunications System (UMTS). In brief, the transmitting end and the receiving end must be in sync with each other during the ciphering and deciphering process. That is, the transmitting end and the receiving end should have consistent ciphering-deciphering parameters, including the ciphering key (denoted as “CK”), the ciphering counter (denoted as “COUNT-C”), the radio bearer identifier (denoted as “BEARER”), the direction identifier (denoted as “DIRECTION”), and the length indicator (denoted as “LENGTH”). According to the ciphering-deciphering parameters, the transmitting end first generates a keystream (denoted as “KEYSTREAM BLOCK”) using the algorithm “f8” and then generates a ciphered data (denoted as “CIPHERTEXT BLOCK”) by eXclusiveOR(XOR)-ing the keystream and the original data (denoted as “PLAINTEXT BLOCK”). When receiving the ciphered data, the receiving end first generates another keystream using the algorithm “f8” and the ciphering-deciphering parameters, and then obtains the original data by XOR-ing the another keystream and the ciphered data.

In order to keep consistent ciphering-deciphering parameters in the transmitting end and the receiving end, the UE determines new ciphering-deciphering parameters and an activation time for activating the new ciphering-deciphering parameters when an update of the ciphering-deciphering parameters is required, and then transmits the new ciphering-deciphering parameters and the activation time to the service network on the uplink channel. Nevertheless, there are situations where data transmission on the uplink channel may fail or may not be successful before the activation time is reached due to the UE being moved to an area with bad reception. In such cases, when the activation time is reached, the UE may apply new ciphering-deciphering parameters, while the service network may still be using the old ciphering-deciphering parameters. If such inconsistencies between the applied and used ciphering-deciphering parameters occur between the UE and the service network, machine sounds (or water sounds or garbage sounds) may occur during voice calls and the quality of the voice calls may be greatly degraded.

### BRIEF SUMMARY OF THE INVENTION

Accordingly, embodiments of the invention provide mobile communication devices and deciphering methods for efficient recovery from ciphering-deciphering parameter inconsistencies. In one aspect of the invention, a mobile communication device comprising a wireless module and a controller module is provided. The wireless module is arranged for performing wireless transmission and reception to and from a service network. The controller module is arranged for receiving a first ciphered data packet from the service network via the wireless module, and deciphering the first ciphered data packet according to a first deciphering parameter. Also, the controller module is arranged for deciphering the first ciphered data packet according to a second deciphering parameter in response to unsuccessful deciphering of the first ciphered data packet according to the first deciphering parameter, wherein the second deciphering parameter is for deciphering a second ciphered data packet received prior to the first ciphered data packet from the service network.

In another aspect of the invention, a deciphering method applied to a mobile communication device wirelessly connected to a service network is provided. The deciphering method comprises the steps of receiving a first ciphered data packet from the service network, deciphering the first ciphered data packet according to a first ciphering-deciphering parameter, and deciphering the first ciphered data packet according to a second ciphering-deciphering parameter in response to unsuccessful deciphering of the first ciphered data packet according to the first ciphering-deciphering parameter, wherein the second ciphering-deciphering parameter is for deciphering a second ciphered data packet received prior to the first ciphered data packet from the service network.

In another aspect of the invention, a mobile communication device comprising a wireless module and a controller module is provided. The wireless module is arranged for performing wireless transmission and reception to and from a service network. The controller module is arranged for receiving a ciphered data packet from the service network via the wireless module, and deciphering the ciphered data packet according to a ciphering-deciphering parameter. Also, the controller module is arranged for transmitting the ciphering-deciphering parameter to the service network via the wireless module in response to unsuccessful deciphering of the ciphered data packet according to the ciphering-deciphering parameter, so that the service network ciphers subsequent data packets to be transmitted according the ciphering-deciphering parameter.

In another aspect of the invention, a deciphering method applied to a mobile communication device wirelessly connected to a service network is provided. The deciphering method comprises the steps of receiving a ciphered data packet from the service network, deciphering the ciphered data packet according to a ciphering-deciphering parameter, and transmitting the ciphering-deciphering parameter to the service network in response to unsuccessful deciphering of the ciphered data packet according to the ciphering-deciphering parameter, so that the service network ciphers subsequent data packets to be transmitted according the ciphering-deciphering parameter.

Other aspects and features of the invention will become apparent to those with ordinary skill in the art upon review of the following descriptions of specific embodiments of the mobile communication devices and the deciphering methods for efficiently recovering from the ciphering-deciphering parameters inconsistency.

### BRIEF DESCRIPTION OF DRAWINGS

The invention can be more fully understood by reading the subsequent detailed description and examples with references made to the accompanying drawings, wherein:

FIG. 1 is a block diagram illustrating the ciphering and deciphering of data communicated in a Universal Mobile Telecommunications System (UMTS);

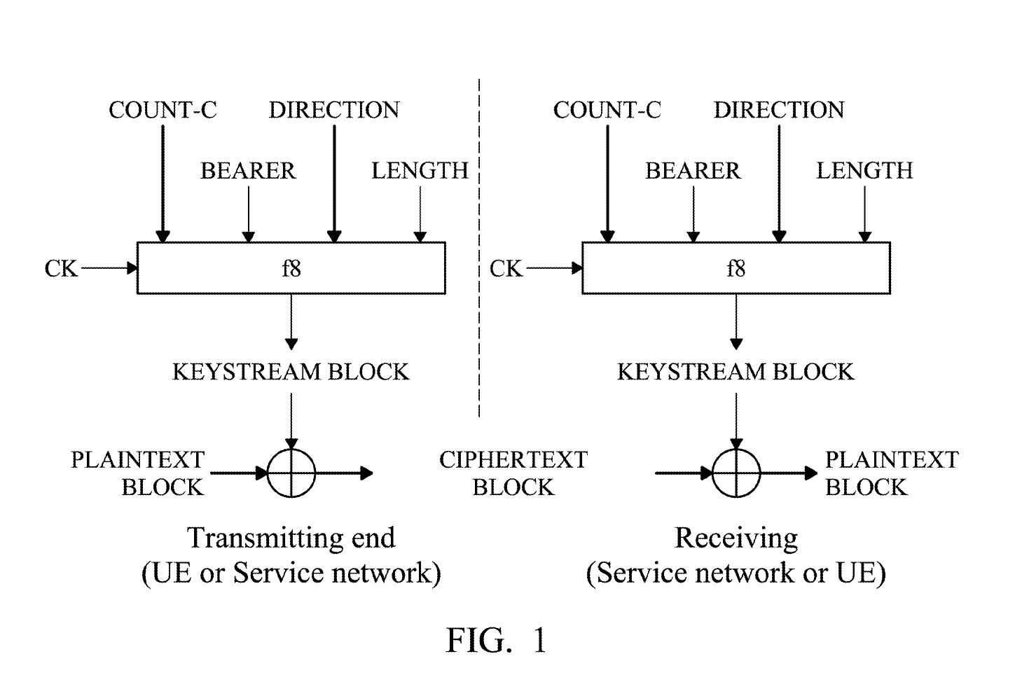

FIG. 2 is a block diagram illustrating a mobile communication system according to an embodiment of the invention;

FIG. 3 is a message sequence chart illustrating a ciphering and deciphering process according to an embodiment of the invention;

FIG. 4 is a block diagram illustrating reversions of the used ciphering-deciphering parameters according to an embodiment of the invention;

FIG. 5 is a message sequence chart illustrating a ciphering and deciphering process according to another embodiment of the invention;

FIG. 6 is a block diagram illustrating retransmissions of the used ciphering-deciphering parameters according to an embodiment of the invention;

FIG. 7 is a flow chart illustrating a deciphering method according to an embodiment of the invention; and

FIG. 8 is a flow chart illustrating a deciphering method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The 3GPP specifications are used to teach the spirit of the invention, and the invention is not limited thereto.

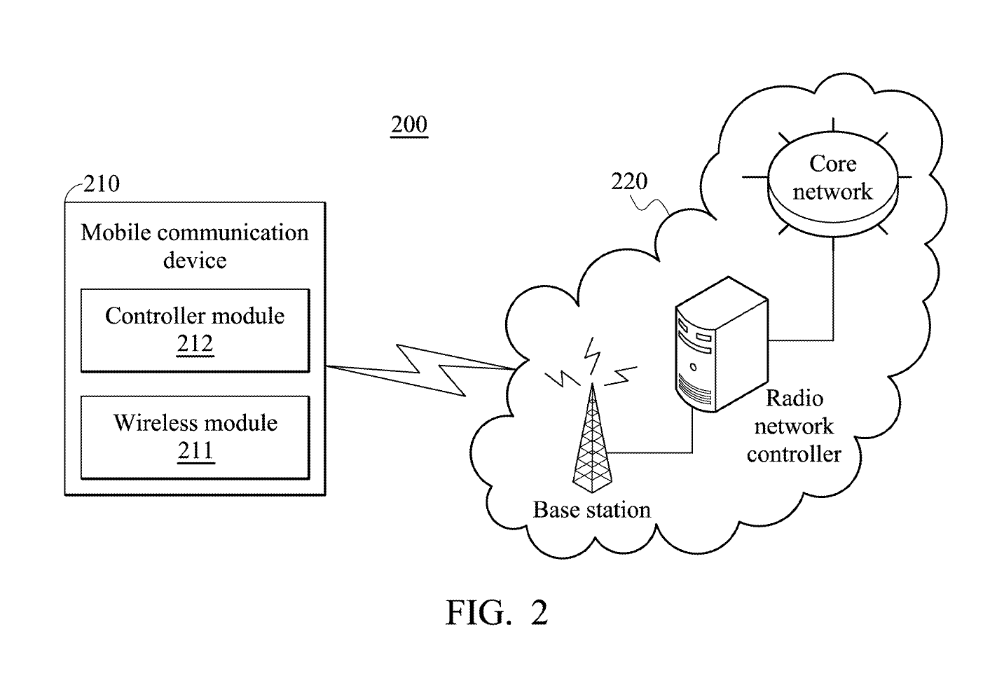

FIG. 2 is a block diagram illustrating a mobile communication system according to an embodiment of the invention. In the mobile communication system 200, the mobile communication device 210 is wirelessly connected to the service network 220 via the air interface for performing wireless transmission and receptions therebetween. The mobile communication device 210 comprises a wireless module 211 for performing the functionality of wireless transmission and reception. To further clarify, the wireless module 211 may comprise a baseband unit (not shown) and a radio frequency (RF) unit (not shown). The baseband unit may contain multiple hardware devices to perform baseband signal processing, including analog to digital conversion (ADC)/digital to analog conversion (DAC), gain adjusting, modulation/demodulation, encoding/decoding, and so on. The RF unit may receive RF wireless signals, convert the received RF wireless signals to baseband signals, which are processed by the baseband unit, or receive baseband signals from the baseband unit and convert the received baseband signals to RF wireless signals, which are later transmitted. The RF unit may also contain multiple hardware devices to perform radio frequency conversion. For example, the RF unit may comprise a mixer to multiply the baseband signals with a carrier oscillated in the radio frequency of the wireless communications system, wherein the radio frequency may be 900 MHz, 1900 MHz, or 2100 MHz utilized in the UMTS systems, or others depending on the radio access technology (RAT) in use. Also, the mobile communication device 210 comprises a controller module 212 for controlling the operation of the wireless module 211 and other functional components, such as a display unit and/or keypad serving as the MMI (man-machine interface), a storage unit storing the program codes of applications or communication protocols, or others.

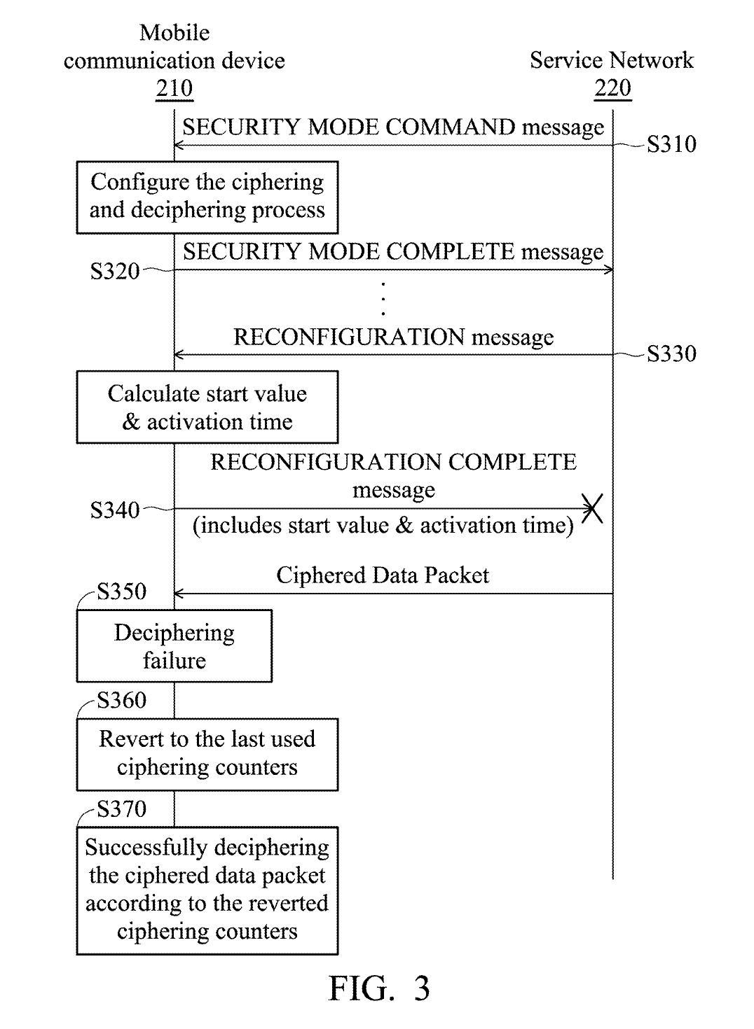

To be more specific, the controller module 212 controls the wireless module 211 for performing the ciphering and deciphering process with the service network 220. FIG. 3 is a message sequence chart illustrating a ciphering and deciphering process according to an embodiment of the invention. After the mobile communication device 210 is connected to the service network 220, the service network 220 transmits a SECURITY MODE COMMAND message to the mobile communication device 210 to start the ciphering and deciphering process for protecting the confidentiality of the data transmissions and receptions therebetween (step S310). The SECURITY MODE COMMAND message may include configurations of the ciphering and deciphering process, such as information concerning the ciphering and deciphering algorithm, activation time, and radio bearers to be protected, etc. In other embodiments, the SECURITY MODE COMMAND message may be used to start the ciphering and deciphering process and the integrity protection process, wherein the SECURITY MODE COMMAND message may include configurations of the integrity protection process, such as the integrity protection algorithm, activation time, and start value, etc. Subsequently, the controller module 212 configures the ciphering and deciphering process according to the SECURITY MODE COMMAND message, including determining the activation time for the ciphering and deciphering process, and then the controller module 212 transmits a SECURITY MODE COMPLETE message to the service network 220 via the wireless module 211 when the configuration of the ciphering and deciphering process is complete (step S320). Later, at the activation time, both of the mobile communication device 210 and the service network 220 start ciphering the data packets to be transmitted and deciphering the received data packets.

After starting the ciphering and deciphering process, the mobile communication device 210 and the service network 220 may each maintain two ciphering counters for each established radio bearer, which count the number of transmitted and received ciphered data packet, respectively, for the ongoing ciphering and deciphering process. Specifically, for each radio bearer configured in the Acknowledge Mode (AM) and the Un-acknowledge Mode (UM) of the Radio Link Control (RLC), the mobile communication device 210 maintains two ciphering counters for counting the number of transmitted and received ciphered data packet, respectively. For all radio bearers configured in the Transparent Mode (TM) of the RLC, the mobile communication device 210 maintains a single ciphering counter for counting the number of transmitted and received ciphered data packets.

Next, when an update of the ciphering-deciphering parameters is required, e.g., the ciphering key or the ciphering counter is needed to be updated or reconfigured, the service network 220 transmits to the mobile communication device 210 a RECONFIGURATION message indicating that an update of the ciphering-deciphering parameters is required (step S330). Regarding the detailed description of the situations where updates of the ciphering-deciphering parameters may be required, reference may be made to the specification TS 33.102, CH6.4.3, for the UMTS system standardized by the 3rd Generation Partnership Project (3GPP), thus, it is omitted herein. In response to the RECONFIGURATION message, the controller module 212 checks the ciphering counters of all established radio bearers and calculates a start value for updating the ciphering counters according to the following equation:

$$START = {MSB}_{20} ( MAX \{ \begin{matrix}COUNT - C , COUNT - I \\ SecurityProtected\_RBs\end{matrix} \} ) + 2 ,$$

wherein “SecurityProtected_RBs” represent all radio bearers that are ciphering and integrity protected. Also, the controller module 212 determines the activation time for updating the ciphering counters. After that, the controller module 212 includes the start value and the activation time in a RECONFIGURATION COMPLETE message and then transmits the RECONFIGURATION COMPLETE message to the service network 220 via the wireless module 211 (step S340). However, in this embodiment, the transmission of the RECONFIGURATION COMPLETE message fails due to the mobile communication device 210 moving to an area with bad reception, so accordingly, the controller module 212 may initiate a layer-two (i.e., L2 of the utilized mobile communication protocol) retransmission mechanism to retransmit the RECONFIGURATION COMPLETE message to the service network 220 via the wireless module 211. However, due to the mobile communication device 210 still being in an area with bad reception, the retransmission of the RECONFIGURATION COMPLETE message would not be successful before the activation time for updating the ciphering counters. Thus, at the activation time, the controller module 212 would use the start value, to replace the 20 Most Significant Bits (MSB) of all ciphering counters, while the service network 220 continues to use the non-updated ciphering counters. Later, when the mobile communication device 210 moves to an area with fair reception, the controller module 212 would try to decipher the ciphered data packet subsequently received from the service network 220. However, the deciphering would fail due to the inconsistencies of the ciphering counters used by the mobile communication device 210 and the service network 220 (step S350). The deciphering failure further causes machine sounds in the ongoing voice call. The detailed description of the ciphering counters and the start value is omitted here as it is beyond the scope of the invention, and reference may be made to the specifications TS 33.102, CH6.4.3, and TS 25.331 for the UMTS system standardized by the 3GPP.

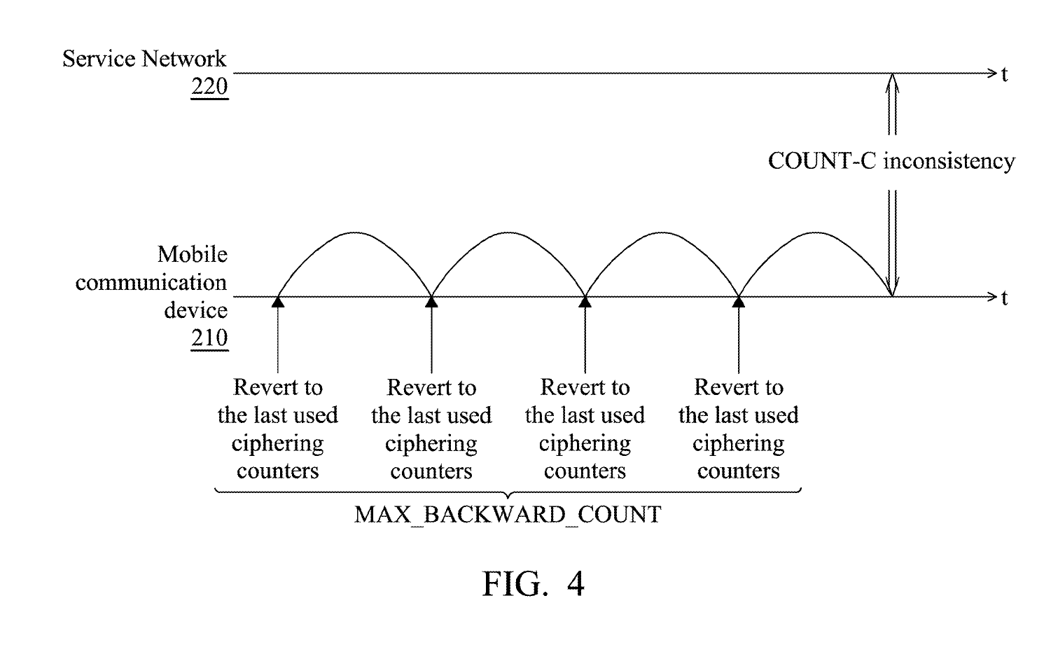

Accordingly, the invention proposes two solutions for the deciphering failure caused by the inconsistencies of the ciphering counters used by the mobile communication device 210 and the service network 220. In the first solution, as shown in FIG. 3, the controller module 212 reverts back to using the old ciphering counters (i.e., the ciphering counters used before the update with the start value) for the ciphering and deciphering process (step S360). That is, the controller module 212 would store the old ciphering counters before updating the old ciphering counters with the start value. Subsequently, the controller module 212 may decipher the ciphered data packet subsequently received from the service network 220 according to the old ciphering counters (step S370). In this embodiment, after the mobile communication device 210 reverts back to using the old ciphering counters, the ciphering counters used by the mobile communication device 210 and the service network 220 would now be consistent, so that the controller module 212 may successfully decipher the ciphered data packet subsequently received from the service network 220 and the problem of machine sounds would be resolved. Then, the controller module 212 would continue to use the old ciphering counters for counting the number of transmitted and received ciphered data packet during the ciphering and deciphering process. In another embodiment, the steps S330 to S350 may be repeated due to the mobile communication device 210 being in an area with bad reception. For this case, reverting to the last used ciphering counters may not achieve successful deciphering of the ciphered data packet subsequently received from the service network 220, so the controller module 212 may repeat the steps S360 and S370 until the ciphered data packet subsequently received from the service network 220 is successfully deciphered. In addition, the controller module 212 may determine a predetermined number of times for the repetition of the step of reverting to the last used ciphering counters to be performed. When the step of reverting to the last used ciphering counters has been repeated for the predetermined number of times, the controller module 212 may stop the ciphering and deciphering process, as shown in FIG. 4.

The RECONFIGURATION message as mentioned beforehand may be a PHYSICAL CHANNEL RECONFIGURATION message, a RADIO BEARER RECONFIGURATION message, a RADIO BEARER RELEASE message, a RADIO BEARER SETUP message, a TRANSPORT CHANNEL RECONFIGURATION message, a HANDOVER TO UTRAN message, or a UTRAN MOBILITY INFORMATION message in the UMTS or Long Term Evolution (LTE) system. Correspondingly, the RECONFIGURATION COMPLETE message may be a PHYSICAL CHANNEL RECONFIGURATION COMPLETE message, a RADIO BEARER RECONFIGURATION COMPLETE message, a RADIO BEARER RELEASE COMPLETE message, a RADIO BEARER SETUP COMPLETE message, a TRANSPORT CHANNEL RECONFIGURATION COMPLETE message, a HANDOVER TO UTRAN COMPLETE message, or a UTRAN MOBILITY INFORMATION CONFIRM message in the UMTS or LTE system.

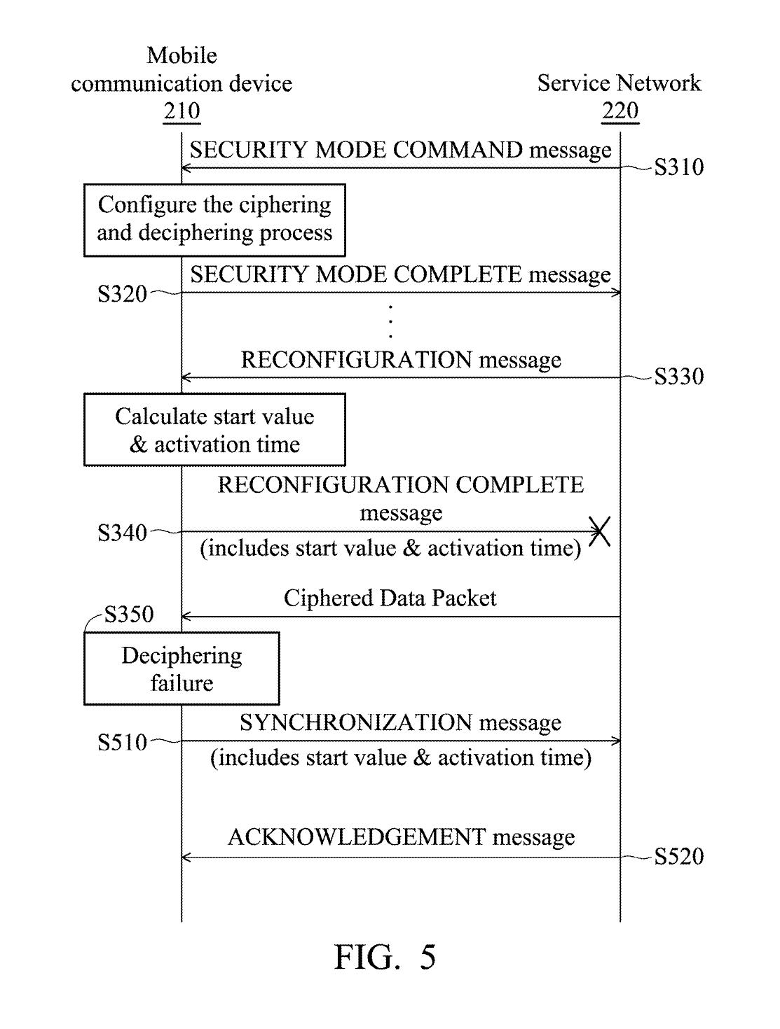

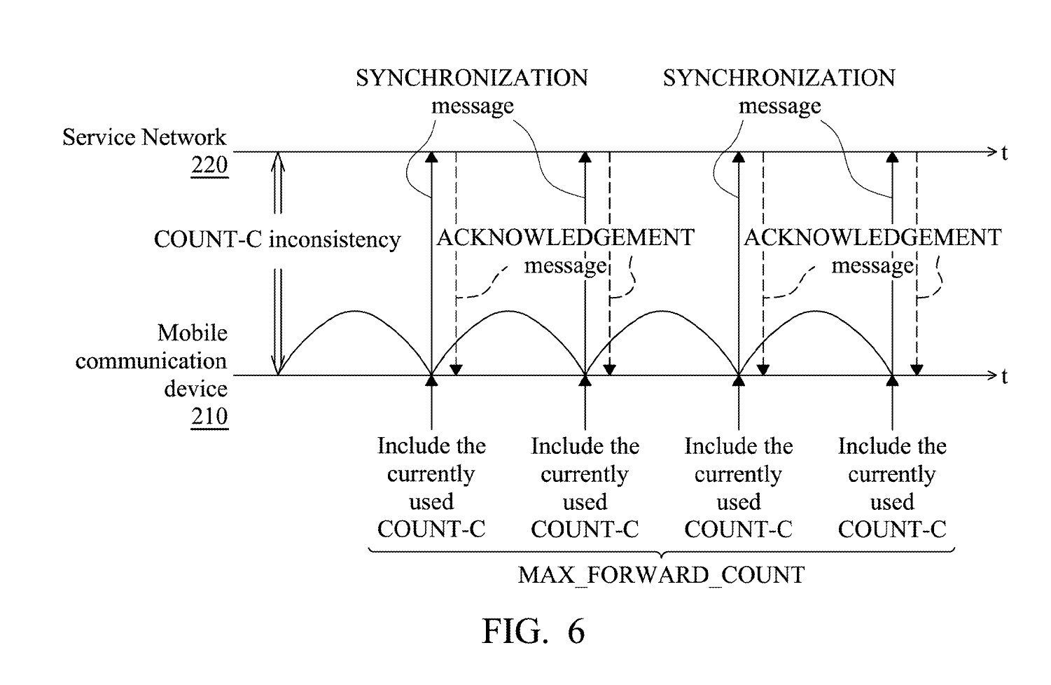

In the second solution as shown in FIG. 5, when detecting the deciphering failure caused by the inconsistencies of the ciphering counters used by the mobile communication device 210 and the service network 220, the controller module 212 includes the start value and the activation time in a SYNCHRONIZATION message and then transmits the SYNCHRONIZATION message to the service network 220 via the wireless module 211 (step S510). In response to receiving the SYNCHRONIZATION message, the service network 220 replies to the mobile communication device 210 with an ACKNOWLEDGEMENT (ACK) message (step S520), and updates the ciphering counters with the start value at the activation time as indicated in the SYNCHRONIZATION message, so that the mobile communication device 210 and the service network 220 may use consistent ciphering counters since the activation time, and the ciphering and deciphering process would continue smoothly. When receiving the ACKNOWLEDGEMENT message, the controller module 212 would know that the SYNCHRONIZATION message has been successfully delivered to the service network 220. In another embodiment, the steps S330 to S350 may be repeated due to the mobile communication device 210 being in an area with bad reception. For this case, the controller module 212 may repeat the step S510 until an ACKNOWLEDGEMENT message is received. In addition, the controller module 212 may determine a predetermined number of times for the repetition of the step S510 to be performed. When the step S510 has been repeated for the predetermined number of times, the controller module 212 may stop retransmitting the SYNCHRONIZATION message and stop the ciphering and deciphering process, as shown in FIG. 6.

The SYNCHRONIZATION message may be a CELL UPDATE message or an UTRAN Routing Area (URA) UPDATE message in the UMTS or LTE system. Correspondingly, the ACKNOWLEDGEMENT message may be a CELL UPDATE CONFIRM message or an URA UPDATE CONFIRM message in the UMTS or LTE system.

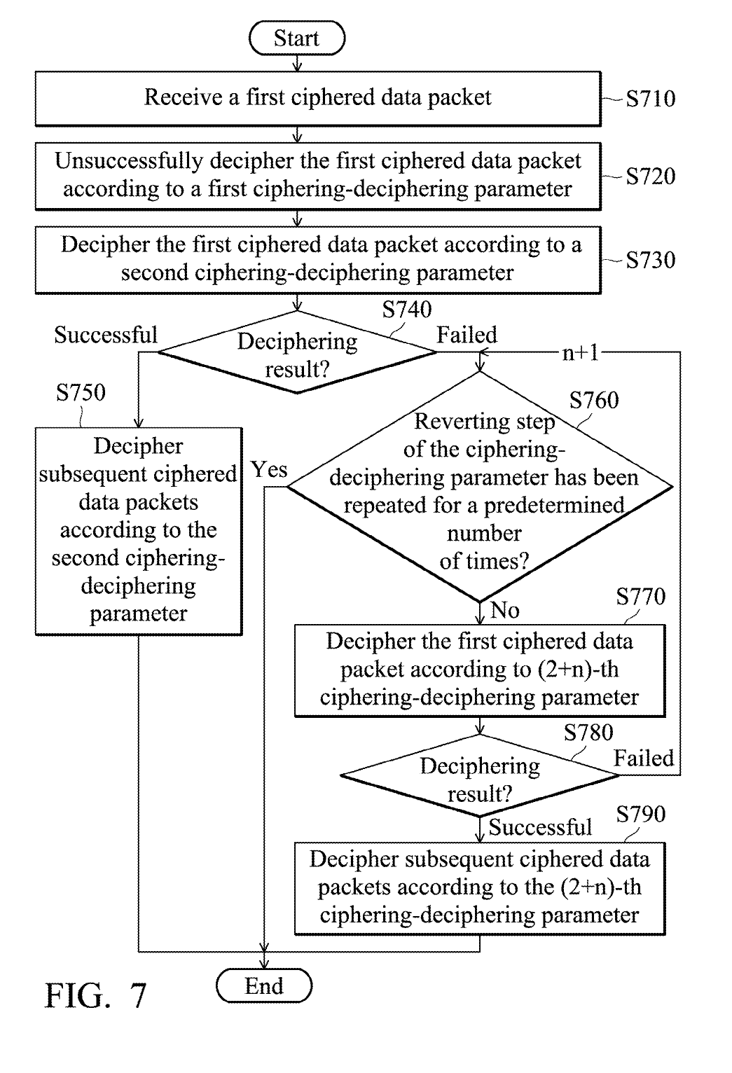

FIG. 7 is a flow chart illustrating a deciphering method according to an embodiment of the invention. In this embodiment, the first solution of the invention described above is adopted in the deciphering method, and the deciphering method is applied in a mobile communication device for deciphering the ciphered data packets received from a service network, wherein the mobile communication device is wirelessly connected with the service network and the ciphering and deciphering process therebetween is initiated. Particularly, the wireless transmission and reception between the mobile communication device and the service network is in compliance with the specifications for the UMTS system or LTE system. To begin the deciphering method, the mobile communication device receives a first ciphered data packet from the service network (step S710), and then deciphers the first ciphered data packet according to a first ciphering-deciphering parameter (step S720). In response to unsuccessful deciphering of the first ciphered data packet according to the first ciphering-deciphering parameter, the mobile communication device further deciphers the first ciphered data packet according to a second ciphering-deciphering parameter (step S730), wherein the second ciphering-deciphering parameter is for deciphering a second ciphered data packet received prior to the first ciphered data packet from the service network. Specifically, each of the first and second ciphering-deciphering parameters may refer to a respective ciphering counter for counting the number of transmitted and/or received ciphered data packet, and the mobile communication device reverts back to using the last used ciphering counters for the ciphering and deciphering process.

Subsequently, the mobile communication device determines whether the deciphering of the first ciphered data packet according to the second ciphering-deciphering parameter is successful (step S740). If so, the mobile communication device continues to decipher the subsequent ciphered data packets received from the service network according to the second ciphering-deciphering parameter (step S750). Otherwise, if the deciphering of the first ciphered data packet according to the second ciphering-deciphering parameter fails, the mobile communication device determines whether the step of reverting to the last used ciphering-deciphering parameter has been repeated for a predetermined number of times (step S760). If not, the mobile communication device further deciphers the first ciphered data packet according to a third (denoted as “2+n” in FIG. 7, and n is initialized to 1) ciphering-deciphering parameter (step S770), wherein the third ciphering-deciphering parameter is for deciphering a third ciphered data packet received prior to the second ciphered data packet from the service network. After that, the mobile communication device determines whether the deciphering of the first ciphered data packet according to the third ciphering-deciphering parameter is successful (step S780). If so, the mobile communication device continues to decipher the subsequent ciphered data packets received from the service network according to the third (denoted as “2+n” in FIG. 7) ciphering-deciphering parameter (step S790). Otherwise, if the deciphering of the first ciphered data packet according to the third ciphering-deciphering parameter fails, the mobile communication device repeats the steps S760 and S770 to revert to using a ciphering-deciphering parameter used before the last used ciphering-deciphering parameter, until the step of reverting to the last used ciphering-deciphering parameter has been repeated for the predetermined number of times. Note that, the use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

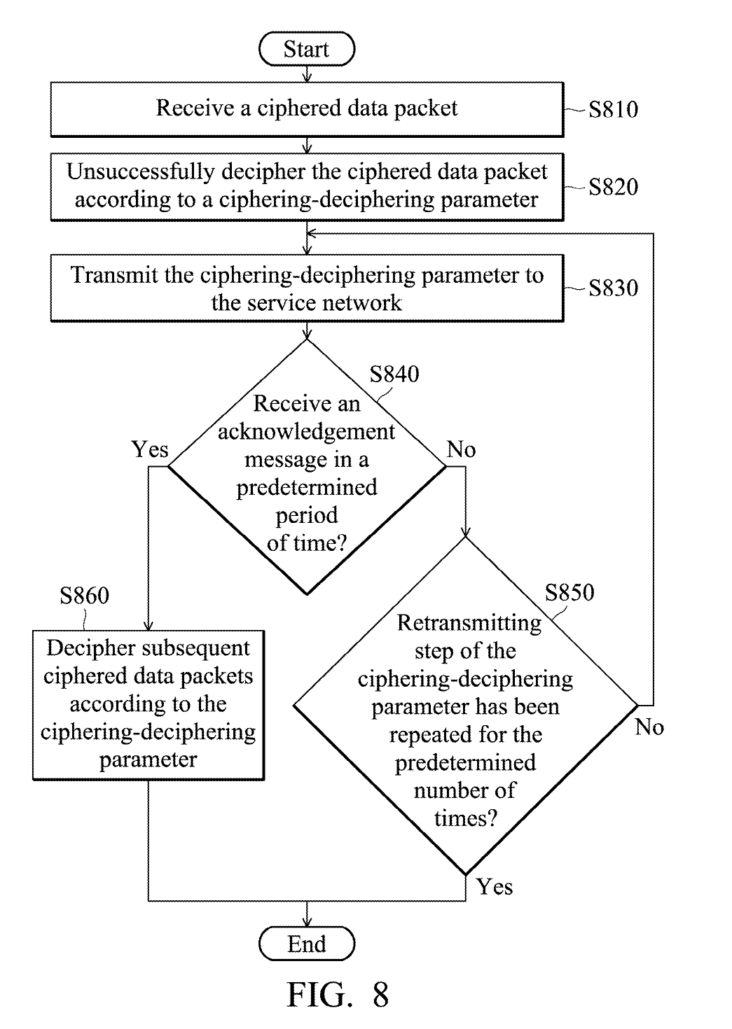

FIG. 8 is a flow chart illustrating a deciphering method according to another embodiment of the invention. In this embodiment, the second solution of the invention as described above is adopted in the deciphering method, and the deciphering method is applied in a mobile communication device for deciphering the ciphered data packets received from a service network, wherein the mobile communication device is wirelessly connected with the service network and the ciphering and deciphering process therebetween is initiated. Particularly, the wireless transmission and reception between the mobile communication device and the service network is in compliance with the specifications for the UMTS system or LTE system. To begin the deciphering method, the mobile communication device receives a ciphered data packet from the service network (step S810), and then deciphers the ciphered data packet according to a ciphering-deciphering parameter (step S820). In response to unsuccessful deciphering of the ciphered data packet according to the ciphering-deciphering parameter, the mobile communication device further transmits the ciphering-deciphering parameter to the service network (step S830), so that the service network ciphers subsequent data packets to be transmitted according the ciphering-deciphering parameter. Specifically, the ciphering-deciphering parameter is transmitted along with information concerning an activation time to the service network, wherein the activation time indicates the time for applying the ciphering-deciphering parameter. That is, the service network uses the old ciphering-deciphering parameter before the activation time, and applies the ciphering-deciphering parameter received from the mobile communication device at the activation time. In this embodiment, the ciphering-deciphering parameter may refer to a ciphering counter for counting the number of transmitted and/or received ciphered data packet.

Subsequently, the mobile communication device waits to receive an acknowledgement message from the service network within a predetermined period of time (step S840), wherein the acknowledgement message is transmitted by the service network to inform the mobile communication device that the ciphering-deciphering parameter has been successfully received. If no acknowledgement message is received within the predetermined period of time, it is determined that the transmission of the ciphering-deciphering parameter is unsuccessful, so the step S830 is repeated for retransmitting the ciphering-deciphering parameter. It is noted that, a predetermined number of times is configured to limit the maximum number of retries of the transmission of the ciphering-deciphering parameter, and before retransmitting the ciphering-deciphering parameter, the mobile communication device needs to determine whether the retransmission of the ciphering-deciphering parameter has been repeated for the predetermined number of times (step S850). If so, the mobile communication device stops deciphering the ciphered data packet from the service network and the deciphering method ends; otherwise, if not, the step S830 is repeated. Subsequent to step S840, if an acknowledgement message is received from the service network in the predetermined period of time, it is determined that the service network has successfully received the ciphering-deciphering parameter and the service network will use the ciphering-deciphering parameter to cipher the data packets to be transmitted at the activation time. Thus, the mobile communication device then deciphers the ciphered data packets subsequently received from the service network according to the ciphering-deciphering parameter (step S860).

Note that, the ciphering counter(s) in the ciphering-deciphering parameters is incremented by one, upon successful deciphering of each ciphered data packet. In addition, before updating the ciphering-deciphering parameters, the mobile communication device may need to store the currently used ciphering-deciphering parameters for the step of reverting to the last used ciphering-deciphering parameter as described above.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. A mobile communication device, comprising:
a wireless module, arranged for performing wireless transmission and reception to and from a service network; and
a controller module, arranged for receiving a first ciphered data packet from the service network via the wireless module, deciphering the first ciphered data packet according to a first ciphering-deciphering parameter, and deciphering the first ciphered data packet according to a second ciphering-deciphering parameter in response to unsuccessful deciphering of the first ciphered data packet according to the first ciphering-deciphering parameter,
wherein the second ciphering-deciphering parameter is for deciphering a second ciphered data packet received prior to the first ciphered data packet from the service network.

2. The mobile communication device of claim 1, wherein the controller module is further arranged for deciphering ciphered data packets subsequent to the first ciphered data packet according to the second ciphering-deciphering parameter, in response to successful deciphering of the first ciphered data packet according to the second ciphering-deciphering parameter.

3. The mobile communication device of claim 1, wherein each of the first ciphering-deciphering parameter and the second ciphering-deciphering parameter is a respective COUNT-C.

4. The mobile communication device of claim 1, wherein the controller module is further arranged for deciphering the first ciphered data packet according to a third ciphering-deciphering parameter in response to unsuccessful deciphering of the and the third ciphering-deciphering parameter is for deciphering a third ciphered data packet received prior to the second ciphered data packet from the service network.

5. The mobile communication device of claim 4, wherein the step of reverting to the last used ciphering-deciphering parameter is repeated until the first ciphered data packet is successfully deciphered.

6. The mobile communication device of claim 5, wherein the controller module is further arranged for determining a predetermined number of times for the repetition of the step of reverting to the last used ciphering-deciphering parameter to be performed, and stopping deciphering the first ciphered data packet in response to the step of reverting to the last used ciphering-deciphering parameter being repeated for the predetermined number of times.

7. A deciphering method, applied to a mobile communication device wirelessly connected to a service network, the method comprising:
receiving a first ciphered data packet from the service network;
deciphering the first ciphered data packet according to a first ciphering-deciphering parameter; and
deciphering the first ciphered data packet according to a second ciphering-deciphering parameter in response to unsuccessful deciphering of the first ciphered data packet according to the first ciphering-deciphering parameter,
wherein the second ciphering-deciphering parameter is for deciphering a second ciphered data packet received prior to the first ciphered data packet from the service network.

8. The deciphering method of claim 7, further comprising:
deciphering ciphered data packets subsequent to the first ciphered data packet according to the second ciphering-deciphering parameter, in response to successful deciphering of the first ciphered data packet according to the second ciphering-deciphering parameter.

9. The deciphering method of claim 7, wherein each of the first ciphering-deciphering parameter and the second ciphering-deciphering parameter is a respective COUNT-C.

10. The deciphering method of claim 7, further comprising:
deciphering the first ciphered data packet according to a third ciphering-deciphering parameter in response to unsuccessful deciphering of the first ciphered data packet according to the second ciphering-deciphering parameter, wherein the third ciphering-deciphering parameter is for deciphering a third ciphered data packet received prior to the second ciphered data packet from the service network.

11. The deciphering method of claim 10, further comprising:
repeating the step of reverting to the last used ciphering-deciphering parameter until the first ciphered data packet is successfully deciphered.

12. The deciphering method of claim 11, further comprising:
determining a predetermined number of times for the repetition of the step of reverting to the last used ciphering-deciphering parameter to be performed, and stopping deciphering the first ciphered data packet in response to the step of reverting to the last used ciphering-deciphering parameter being repeated for the predetermined number of times.

13. A mobile communication device, comprising:
a wireless module, arranged for performing wireless transmission and reception to and from a service network; and
a controller module, arranged for receiving a ciphered data packet from the service network via the wireless module, deciphering the ciphered data packet according to a ciphering-deciphering parameter, and transmitting the ciphering-deciphering parameter to the service deciphering of the ciphered data packet according to the ciphering-deciphering parameter, so that the service network ciphers subsequent data packets to be transmitted according the ciphering-deciphering parameter.

14. The mobile communication device of claim 13, wherein the ciphering-deciphering parameter is transmitted along with information concerning an activation time to the service network, and the ciphering of the subsequent data packets to be transmitted according the ciphering-deciphering parameter is performed at the activation time.

15. The mobile communication device of claim 14, wherein the service network replies with an acknowledgement message in response to receiving the ciphering-deciphering parameter, and the controller module is further arranged for deciphering ciphered data packets subsequently received from the service network according to the ciphering-deciphering parameter in response to receiving the acknowledgement message.

16. The mobile communication device of claim 15, wherein the controller module further repeats the step of transmitting the ciphering-deciphering parameter to the service network, in response to not receiving the acknowledgement message within a predetermined period of time.

17. The mobile communication device of claim 16, wherein the controller module is further arranged for determining a predetermined number of times for the repetition of the step of transmitting the ciphering-deciphering parameter to the service network to be performed, and stops deciphering any ciphered data packet received from the service network in response to the step of transmitting the ciphering-deciphering parameter to the service network being repeated for the

18. A deciphering method, applied to a mobile communication device wirelessly connected to a service network, the method comprising:
receiving a ciphered data packet from the service network;
deciphering the ciphered data packet according to a ciphering-deciphering parameter; and
transmitting the ciphering-deciphering parameter to the service network in response to unsuccessful deciphering of the ciphered data packet according to the ciphering-deciphering parameter, so that the service network ciphers subsequent data packets to be transmitted according the ciphering-deciphering parameter.

19. The deciphering method of claim 18, wherein the ciphering-deciphering parameter is transmitted along with information concerning an activation time to the service network, and the ciphering of the subsequent data packets to be transmitted according the ciphering-deciphering parameter is performed at the activation time.

20. The deciphering method of claim 18, wherein the service network replies with an acknowledgement message in response to receiving the ciphering-deciphering parameter, and the deciphering method further comprises:
deciphering ciphered data packets subsequently received from the service network according to the ciphering-deciphering parameter in response to receiving the acknowledgement message.

21. The deciphering method of claim 20, further comprising:
repeating the step of transmitting the ciphering-deciphering parameter to the service network, in response to not receiving the acknowledgement message within a predetermined period of time.

22. The deciphering method of claim 21, further comprising:
determining a predetermined number of times for the repetition of the step of network to be performed, and stopping deciphering any ciphered data packet received from the service network in response to the step of transmitting the ciphering-deciphering parameter to the service network being repeated for the predetermined number of times.
